(19) United States
(12) Patent Application Publication
(10) Pub. No.: US 2002/0073608 A1
(43) Pub. Date: Jun. 20, 2002

(54) TACKLE HOLDER

(76) Inventor: JAMES BROBERG, CRYSTAL LAKE, IL (US)

Correspondence Address: KEITH A VOGT, NIRO SCAVONE HALLER & NIRO, 181 WEST MADISON STREET, SUITE 4600, CHICAGO, IL, 60602

(21) Appl. No.: 09/373,937

(22) Filed: Aug. 13, 1999

(51) Int. Cl. A01K 97/06

(52) U.S. Cl. 43/57.1

(57) ABSTRACT

A tackle holder for releasably holding tackle items such as hooks, pliers, files, and other related tools. The holder has an elongated housing which holds a hook holder. The holder is made of a pierceable material which releasably secures hoods and lures. Also included is a tool holder made from two opposingly located plates. The plates have corresponding apertures for holding the tools in an upright position.

### BACKGROUND OF THE INVENTION

The present invention relates to a device for storing and organizing fishing implements. More specifically, the device is a hook, tackle, and tool organizer that is mountable to a support surface on a fishing craft.

### SUMMARY OF THE INVENTION

When engaging in the sport of fishing, it is often desirable to have preselected tackle items stored in a readily accessible location. Such items of tackle may include hooks, lures, pliers, screwdrivers, file and a knife or razor for cutting fishing line. However, because of the craft's movement and the close operating quarters, it is desirable to have a device that secures preselected tackle items in an easily accessible location.

The present invention provides such a device. The tackle holder of the present invention includes an elongated housing which is mountable to a support surface. It has a pierceable hook holder which releasably secures fishing hooks and lures. Also included is a tool support which is comprised of two outwardly extending plates with a plurality of matching apertures and a razor holder.

### DESCRIPTION OF THE DRAWINGS

These and other features, objects and advantages of the present invention will become apparent from the following description and drawings wherein like reference numerals represent like elements in the several views, and in which:

FIG. 1 is a perspective view of the present invention.

### DESCRIPTION OF THE PREFERRED EMBODIMENT

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

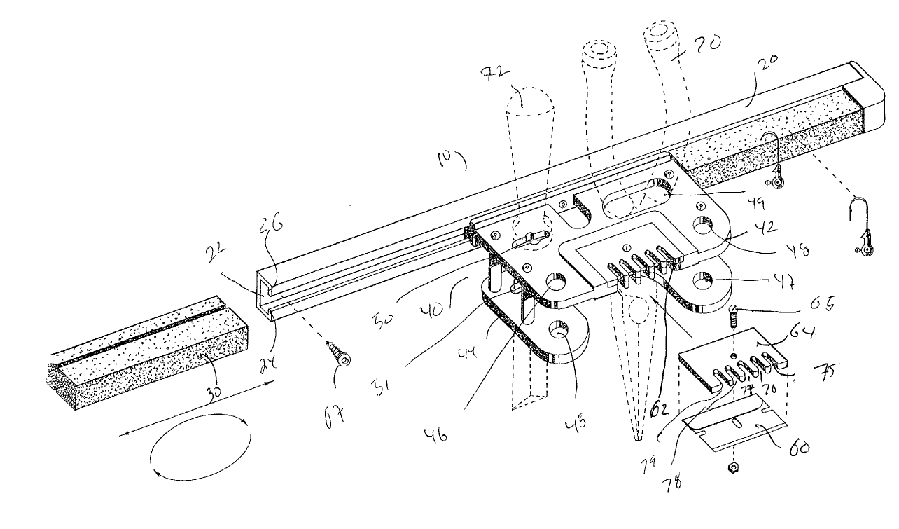

As shown in FIG. 1, tackle holder 10 is comprised of an elongated housing 20 which defines an interior cavity 22 and opposing fingers 24 and 26. Located in cavity 22 and slidably secured by fingers 24 and 26 is a hook retainer or holder 30 which is a deformable, sponge-like material which may be pierced by a hook and which releasably secures the hook. This allows the retainer 30 to be replaced when worn.

Also included is a tool support 40 which may be affixed to or is integrated with housing 20. Support 40 is comprised of a first plate 42 and opposingly located second plate 44.

A plurality of apertures 45-51 of various sizes and shapes are located on plates 42, and 44. Apertures 45-51 may be linearly aligned and matching in shape. Configuring the plates in this corresponding manner provides two points of contact along a tool which maintains the tool in an upright position.

As also shown in FIG. 1, a removable safety razor 60 is also provided. It is located in a recess 62 in plate 42 and is secured in place by cover 64 which is attached to plate 42 by fasteners.

Plate 42 and cover 64 also have a series of corresponding detents 75-79 which extend beyond the outer edge of razor 60.

In use, housing 20 is first secured to a support surface by fasteners 67 or adhesive. Fishing hooks and lures may then be attached to holder 30 by inserting the pointed hook portion into the pierceable material. This securely holds the hook which is easily removed when needed. Other tackle items, such as pliers 70, file 72 and the like are inserted through the appropriately sized corresponding apertures. As described above, because an opposingly matched aperture is also provided, two opposing contact points are employed which maintain the tool upright. The detents permit a line to be inserted toward the razor for cutting while preventing the razor from contacting larger objects such as a user's hand and the like.

It should be understood that various changes and modifications to the preferred embodiments described would be apparent to those skilled in the art. Changes and modifications can be made without departing from the spirit and scope of the present invention and without diminishing its intended advantages. It is, therefore, intended that such changes and modifications be covered by the following claims.

What is claimed is:

1. A tackle holder comprising:
an elongated housing mountable to a support surface, said housing defining an interior space;
a deformable hook holder for releasably securing a hook, said holder retainingly held in said interior space and extending outwardly therefrom;
at least two plates extending outwardly from said housing, said plates having corresponding apertures; and
said apertures adapted to receive tackle and to engage said tackle at two opposing contact points to hold said tackle in an upright position.

2. The device of claim 1 wherein one of said plates is adapted to retainingly secure a razor.

3. The device of claim 2 wherein said razor retaining plate includes a plurality of detents, said plate adapted to coact with a cover plate having corresponding detents to secure said razor to said plate.

4. The device of claim 1 wherein said hook holder is replaceable when worn.
